(19) United States
(12) Patent Application Publication
(10) Pub. No.: US 2004/0007449 A1
(43) Pub. Date: Jan. 15, 2004

(54) Add-on, suspended heater for liquid metal micro-switch

(76) Inventor: Lewis R. Dove, Monument, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/192,387

(22) Filed: Jul. 10, 2002

(51) Int. Cl. H01H 51/22

(52) U.S. Cl. 200/182

(57) ABSTRACT

An apparatus for heating a gas in a cavity of a microcircuit. The apparatus comprises a heater. The heater is located inside the cavity of the microcircuit and is attached to the structure of the microcircuit. The attachment area of the heater to the structure of the microcircuit is substantially less than the back surface area of the heater. An add-on, suspended heater is disclosed in the embodiments described herein.

### FIELD OF THE INVENTION

The present invention relates generally to the field of radio-frequency and microwave microcircuit modules, and more particularly to liquid metal micro-switches used in such modules.

### BACKGROUND OF THE INVENTION

Electronic circuits of all construction types typically have need of switches and relays. The typical compact, mechanical contact type relay is a lead relay. A lead relay comprises a lead switch, in which two leads composed of a magnetic alloy are contained, along with an inert gas, inside a miniature glass vessel. A coil for an electromagnetic drive is wound around the lead switch, and the two leads are installed within the glass vessel as either contacting or non-contacting.

Lead relays include dry lead relays and wet lead relays. Usually with a dry lead relay, the ends (contacts) of the leads are composed of silver, tungsten, rhodium, or an alloy containing any of these, and the surfaces of the contacts are plated with rhodium, gold, or the like. The contact resistance is high at the contacts of a dry lead relay, and there is also considerable wear at the contacts. Since reliability is diminished if the contact resistance is high at the contacts or if there is considerable wear at the contacts, there have been various attempts to treat the surface of these contacts.

Reliability of the contacts may be enhanced by the use of mercury with a wet lead relay. Specifically, by covering the contact surfaces of the leads with mercury, the contact resistance at the contacts is decreased and the wear of the contacts is reduced, which results in improved reliability. In addition, because the switching action of the leads is accompanied by mechanical fatigue due to flexing, the leads may begin to malfunction after some years of use.

A newer type of switching mechanism is structured such that a plurality of electrodes are exposed at specific locations along the inner walls of a slender sealed channel that is electrically insulating. This channel is filled with a small volume of an electrically conductive liquid to form a short liquid column. When two electrodes are to be electrically closed, the liquid column is moved to a location where it is simultaneously in contact with both electrodes. When the two electrodes are to be opened, the liquid column is moved to a location where it is not in contact with both electrodes at the same time.

To move the liquid column, Japanese Laid-Open Patent Application SHO 47-21645 discloses creating a pressure differential across the liquid column is created. The pressure differential is created by varying the volume of a gas compartment located on either side of the liquid column, such as with a diaphragm.

In another development, Japanese Patent Publication SHO 36-18575 and Japanese Laid-Open Patent Application HEI 9-161640 disclose creating a pressure differential across the liquid column by providing the gas compartment with a heater. The heater heats the gas in the gas compartment located on one side of the liquid column. The technology disclosed in Japanese Laid-Open Patent Application 9-161640 (relating to a microrelay element) can also be applied to an integrated circuit. Other aspects are discussed by J. Simon, et al. in the article “A Liquid-Filled Microrelay with a Moving Mercury Drop” published in the Journal of Microelectromechanical Systems, Vol.6, No. 3, September 1997. Disclosures are also made by You Kondoh et al. in U.S. Pat. No. 6,323,447 entitled “Electrical Contact Breaker Switch, Integrated Electrical Contact Breaker Switch, and Electrical Contact Switching Method”.

In order to maintain efficient switch operation in this latter type of switch, it is important to maximize the heat transferred to the gas, thereby minimizing any other heat transfers. Unfortunately, it has been found that a large percentage of the heat, which can be 95% or more, is lost to the substrate and is thus unavailable for causing the gas to expand. The greater the heat loss, the more power required for switch functioning and the slower will be that functioning. Thus, it is important to provide a means for reducing the heat loss from such heaters.

### SUMMARY OF THE INVENTION

In representative embodiments, an apparatus for heating a gas in a cavity of a microcircuit is disclosed. The apparatus comprises a heater. The heater is located inside the cavity of the microcircuit and is attached to the structure of the microcircuit. The attachment area of the heater to the structure of the microcircuit is substantially less than the back surface area of the heater. An add-on, suspended heater is disclosed in the embodiments described herein.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements.

FIG. 1A is a drawing of a top view of a heater actuated, liquid metal micro-switch in a microcircuit.

FIG. 1B is a drawing of a side view of the heater actuated, liquid metal micro-switch at section A-A of FIG. 1A.

FIG. 1C is a drawing of a side view of the heater actuated, liquid metal micro-switch at section B-B of FIG. 1A.

FIG. 2A is another drawing of the top view of the heater actuated, liquid metal micro-switch in the microcircuit.

FIG. 2B is still another drawing of the top view of the heater actuated, liquid metal micro-switch in the microcircuit.

FIG. 2C is a drawing of a side view of the heater actuated, liquid metal micro-switch at section C-C of FIG. 2B.

FIG. 3 is a drawing of a suspended heating apparatus as described in various representative embodiments consistent with the teachings of the invention.

FIG. 4 is an enlarged drawing of an attachment area of the suspended heating apparatus to the substrate as in FIG. 3.

FIG. 5 is a drawing of another suspended heating apparatus as described in various representative embodiments consistent with the teachings of the invention.

### DETAILED DESCRIPTION OF THE PREFERRED EMBODIMENTS

As shown in the drawings for purposes of illustration, the present patent document relates to techniques for mounting heaters in liquid metal micro-switches for use in microcircuits. The resultant configurations provide heaters with increased efficiency due to lower heat losses to the substrate on which the circuits are fabricated.

In the following detailed description and in the several figures of the drawings, like elements are identified with like reference numerals.

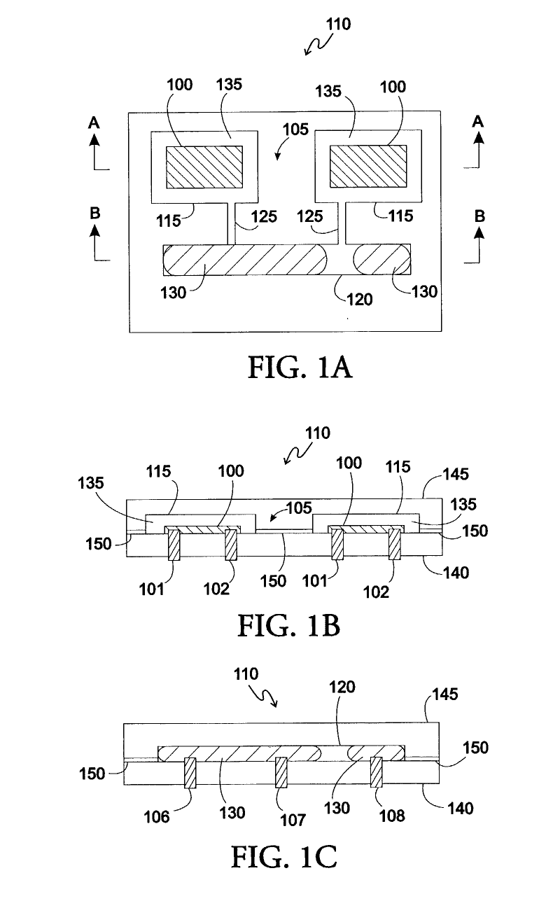

FIG. 1A is a drawing of a top view of a heater 100 actuated, liquid metal micro-switch 105 in a microcircuit 110. The microcircuit 110 of FIG. 1A is more generally referred to as electronic circuit 110. The electronic circuit 110 of FIG. 1A is preferably fabricated using thin film deposition techniques and/or thick film screening techniques which could comprise either single-layer or multi-layer ceramic circuit substrates. While the only component shown in the microcircuit 110 in FIG. 1A is the liquid metal micro-switch 105, it will be understood by one of ordinary skill in the art that other components can be fabricated as a part of the microcircuit 110. In FIG. 1A, the liquid metal micro-switch 105 comprises two heaters 100 located in separate cavities 115. The heaters 100 could be, for example, monolithic heaters 100 fabricated using conventional silicon integrated circuit methods. The cavities 115 are each connected to a main channel 120 via separate sub-channels 125. The main channel 120 is partially filled with a liquid metal 130 which is typically mercury 130. The cavities 115, the sub-channels 125, and that part of the main channel 120 not filled with the liquid metal 130 is filled with a gas 135, which could be, for example, an inert gas such as nitrogen 135. In the switch state shown in FIG. 1A, the mercury 130 is divided into two pockets of unequal volumes. Note that the left hand volume in FIG. 1A is greater than that of the right hand volume. The functioning of the liquid metal micro-switch 105 will be explained in the following paragraphs.

FIG. 1B is a drawing of a side view of the heater 100 actuated, liquid metal micro-switch 105 at section A-A of FIG. 1A. Section A-A is taken along a plane passing through the heaters 100. In FIG. 1B, the heaters 100 are mounted to a substrate 140 upon which the microcircuit 110 is fabricated. A lid 145, which is sealed at mating surfaces 150, covers the liquid metal micro-switch 105. Electrical contact is made separately to the heaters 100 via first and second heater contacts 101,102 to each of the heaters 100. An electric current passed through the left side heater 100 will cause the gas 135 in the left side cavity 115 to expand. This expansion continues as part of the gas enters the main channel 120 via the left side sub-channel 125.

FIG. 1C is a drawing of a side view of the heater 100 actuated, liquid metal micro-switch 105 at section B-B of FIG. 1A. Section B-B is taken along a plane passing through the main channel 120. The liquid metal 130 on the left side of FIG. 1C being larger in volume than that on the right side electrically shorts together a first and second micro-switch contacts 106,107 of the liquid metal micro-switch 105, while the volume of the liquid metal 130 on the right side of FIG. 1C being the smaller, a third micro-switch contact 108 also on the right side of FIG. 1C forms an open-circuit.

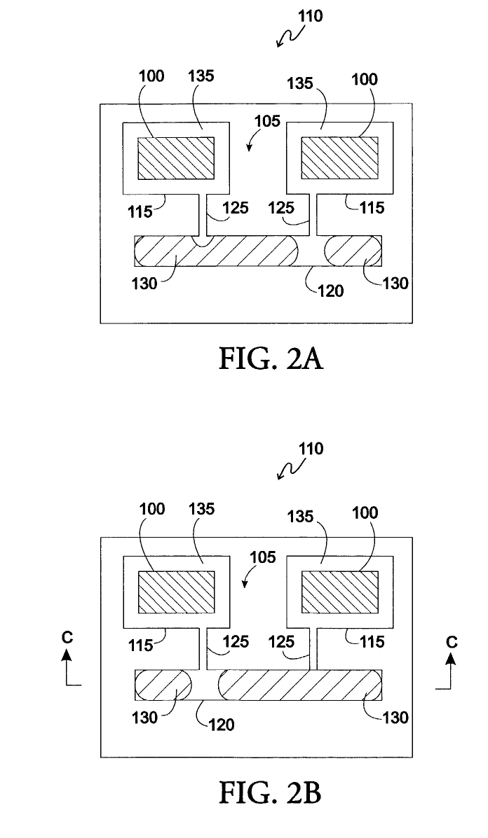

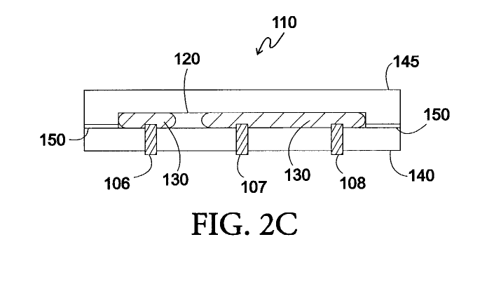

FIG. 2A is another drawing of the top view of the heater 100 actuated, liquid metal micro-switch 105 in the microcircuit 110. FIG. 2A shows the condition of the liquid metal micro-switch 105 shortly after the left side heater 100 has been activated. In this condition, the gas 135 in the left side cavity 115 has been heated just enough to begin forcing, at the interface between the main channel 120 and the left side sub-channel 125, a part of the liquid metal 130 on the left side of the main channel 120 toward the right side of the main channel 120.

FIG. 2B is still another drawing of the top view of the heater 100 actuated, liquid metal micro-switch 105 in the microcircuit 110. FIG. 2B shows the condition of the liquid metal micro-switch 105 after the left side heater 100 has been fully activated. In this condition, the gas 135 in the left side cavity 115 has been heated enough to force a part of the liquid metal 130 originally on the left side of the main channel 120 into the right side of the main channel 120.

FIG. 2C is a drawing of a side view of the heater 100 actuated, liquid metal micro-switch 105 at section C-C of FIG. 2B. Section C-C is taken along a plane passing through the main channel 120. The liquid metal 130 on the right side of FIG. 1C now electrically shorts the second and third micro-switch contacts 107,108 of the liquid metal micro-switch 105 while the first micro-switch contact 106 on the left side of FIG. 2C now forms an open-circuit.

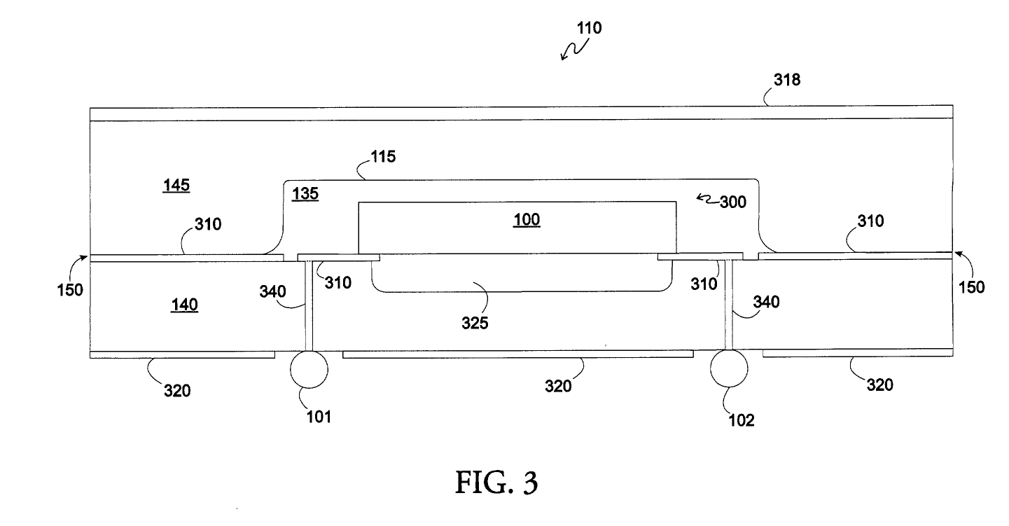

FIG. 3 is a drawing of a suspended heating apparatus 300 as described in various representative embodiments consistent with the teachings of the invention. In FIG. 3, the suspended heating apparatus 300 comprises the heater 100, which could be, for example, a monolithic, integrated circuit 100, which has been suspended over an opening 325 in the substrate 140 by attachment to a conductive layer 310 on the substrate 140. The heater 100 is electrically connected to the first and second heater contacts 101,102 by means of vias 340 and the conductive layer 310. The construction of the microcircuit 110 of which the heater 100 is a part could comprise various conductive layers 310 and dielectric layers 315, not shown in the drawings. Some electrical shielding of the electronic circuit can be provided by upper and lower ground planes 318,320. Attachment of the heater 100 to the conductive layers 310 could be by various means, as for example bonding the heater 100 to the conductive layers 310 via an adhesive or other material or pressure. Covering the heater 100 is the lid 145 attached to the lower part of the structure at mating surface 150.

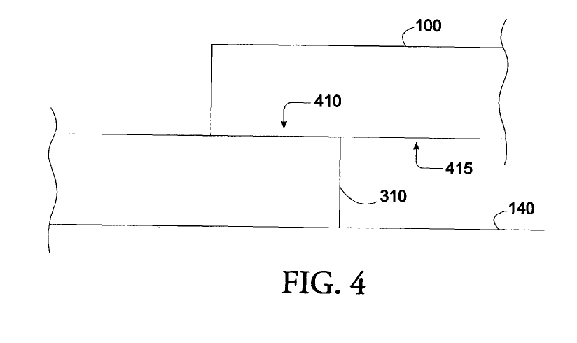

FIG. 4 is an enlarged drawing of an attachment area 410 of the suspended heating apparatus 300 to the substrate 140 as in FIG. 3. In FIG. 4, the attachment area 410 is substantially less than the back surface area 415 of the heater 100. In this representative embodiment, the structure to which the heater 100 is attached is the conductive layers 310 which are attached to the substrate 140.

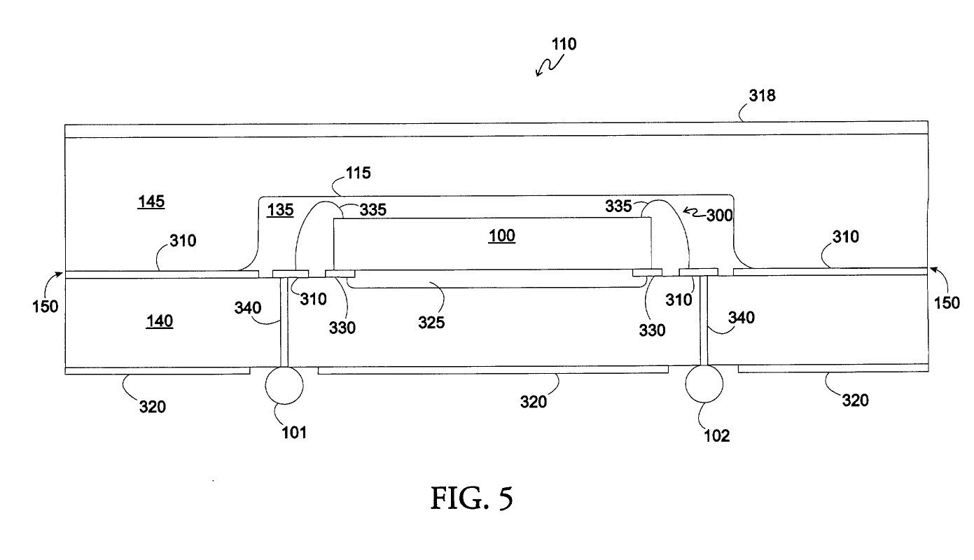

FIG. 5 is a drawing of another suspended heating apparatus 300 as described in various representative embodiments consistent with the teachings of the invention. In FIG. 5, the suspended heating apparatus 300 comprises the heater 100, which could be, for example, a monolithic, integrated circuit 100, which has been suspended over an opening 325 in the substrate 140 by attachment to the substrate 140 on attachment pads 330. The heater 100 is electrically connected to the first and second heater contacts 101,102 by means of wire bonds 335 to conducting layers 310 and vias 340. The typical dielectric layer 315, which again is not required, has not been included in FIG. 5. Some electrical shielding of the electronic circuit can be provided by upper and lower ground planes 318,320. As in FIGS. 4 and 5, the attachment area 410 is substantially less than the back surface area 415 of the heater 100. In this representative embodiment, the structure to which the heater 100 is attached is the conductive layers 310 which are attached to the substrate 140. Covering the heater 100 is the lid 145 attached to the lower part of the structure at mating surface 150.

Embodiments disclosed herein provide means by which add-on suspended heaters 100 can be attached to a circuit substrate 140. The substrate 140 could be fabricated, for example, out of ceramic. The add-on heaters 100 are suspended over an opening 325 in the substrate 140, thus reducing heat loss to the substrate 140. The heaters 100 are attached with a conventional microcircuit adhesive or forced into position via pressure and are suspended over the opening 325 in the substrate 140. This opening can be created by patterning a thick film dielectric or a dielectric tape on top of the base ceramic. Cavities can also be cut into the ceramic by laser for example. Such embodiments can be used with liquid metal micro-switch 105 cavities 115 fabricated using glass channel substrates 140 or with ceramic/dielectric channel substrates 140.

A primary advantage of the embodiments as described herein over prior techniques for attaching heaters 100 in microcircuits 110 is the smaller heat loss that occurs from the heater 100 to the substrate 140. Thus, more heat is available to heat and expand the gas 135 in the heater 100 cavity 115 which results in a lower power requirement for the heater 100, in a faster switching speed for the micro-switch 105, or in a combination of lower power requirement for the heater 100 and a faster switching speed.

While the present invention has been described in detail in relation to preferred embodiments thereof, the described embodiments have been presented by way of example and not by way of limitation. It will be understood by those skilled in the art that various changes may be made in the form and details of the described embodiments resulting in equivalent embodiments that remain within the scope of the appended claims.

What is claimed is:

1. An apparatus for heating a gas in a cavity of a microcircuit, which comprises:
a heater, wherein the heater is located inside the cavity and is attached to the structure of the microcircuit, wherein attachment area of the heater to the structure of the microcircuit is substantially less than the back surface area of the heater.

2. The apparatus as recited in claim 1, wherein the heater is a component in a liquid metal micro-switch.

3. The apparatus as recited in claim 1, wherein the heater is suspended over an opening in the structure of the microcircuit.

4. The apparatus as recited in claim 1, wherein electrical contact is made between conductive layers of the micro-switch and contacts on the heater by wire bonds.

5. The apparatus as recited in claim 1, wherein the contacts of the heater are placed in physical and electrical contact with conductive layers of the micro-switch.

6. The apparatus as recited in claim 1, wherein the heater is a monolithic heater.
